(19) United States
(12) Patent Application Publication
(10) Pub. No.: US 2005/0016154 A1
(43) Pub. Date: Jan. 27, 2005

(54) Lawn rake

(76) Inventor: Gil G. Moreno, Tampa, FL (US)

Correspondence Address: Gil G. Moreno, 4106 Dellbrook Dr., Tampa, FL, 33624, US

(21) Appl. No.: 10/861,433

(22) Filed: Sep. 23, 2004

Related U.S. Application Data
(63) Continuation-in-part of application No. 10/336,558, filed on Jan. 6, 2003, now abandoned.

(51) Int. Cl. A01D 7/00

(52) U.S. Cl. 56/400.21

(57) ABSTRACT

A lawn rake having means to minimize lateral spill of debris. A laminar side skirt, preferably made of flexible plastic and trapezium shape, is secured by a suitable clamp to at least a pair of extreme tines at each side of the lawn rake at a point near the rake head. Each laminar side skirt is hinged to the most extreme tine by means of rings spaced along the tine length. Slidable elliptical links are provided between adjacent tines near their working end to distribute deforming acting forces among all tines.

This Continuation In Part (C.I.P.) of application Ser. No. 10/336,558 is related to application Ser. No. 09/415,495, filed Oct. 12, 1999, now U.S. Pat. No. 6,199,356 B1, granted Mar. 13, 2001; and to abandoned application Ser. No. 09/659,409, filed Sep. 11, 2000.

### BACKGROUND OF THE INVENTION

In order for a Lawn Rake, either manual or motorized, maximize movement of debris, the lateral spill of debris must be minimized. Mullins U.S. Pat. No. 4,312,095 teaches a rake in which two side tine sections are disposed angularly relative to an identical central section to form a conveying funnel-shaped tine assembly. Debris are directed towards the center tine section preventing lateral debris spill. This approach cannot be used in a lawn rake that requires pivoting of the rake assembly in backward motion of the rake to discharge the collected debris and release trapped debris, as it is the case of my cross-referenced inventions. My previous inventions require that all tine working ends be collinear in order that during backing up of the rake all tine working ends rub the grass to release the trapped debris. Wells U.S. Pat. No. 4,009,560 teaches a front loading leaf or ground covering catching device. Obviously the device can reduce the lateral spill of debris, but it is too complicated to manufacture.

### SUMMARY OF THE INVENTION

The principal object of the present invention is to provide a lawn rake that minimizes lateral spill of debris, can be arranged to pivot during backwards motion of the rake to discharge the collected debris and release trapped debris, and is easy and economical to manufacture.

The present invention provides laminar side skirts preferably made of flexible plastic material. Each laminar side skirt is secured to at least a pair of extreme tines by a suitable clamp at a point near the tine head, and is hinged to the most extreme tine by means of rings spaced along the tine length. The laminar side skirts may be secured to the tine head.

Rake tines are subjected to very intense deflecting forces. The tines must be very flexible to be able to bend in all directions to maintain contact with the soil. The flexibility of the tines are determined principally by their material modulus of elasticity, their cross section and the length from the working end to the attachment to their socket head and any wall restricting deflection. The deflecting forces are developed on the tine working ends as well as at the hinging rings of the side skirts.

The present invention provides links between adjacent tines, near its working end. The links are of elliptical shape with their long inner dimension slightly greater than the separation of the tines. Their short inner dimension is defined to allow free movement of the tine inside the link. The links allow each individual tine to bend freely within normal range to follow the contour of the terrain and movement of the lawnmower. During normal range of tine bending, the tine deflecting forces are balanced by the reactive forces at the tine point of attachment to its socket head and at any other contacting wall located at some distance from the tine working end. When the tine bending exceeds the normal range, the links provide additional points to distribute the force among all other tines. The tine links are slidable along the tine length and are prevented from escaping by the tine beads described in my previous patent application or by any other retaining means attached to the tine near its working end.

### BRIEF DESCRIPTION OF THE DRAWINGS

FIG. 1 is a perspective view of a typical lawn rake showing the laminar side skirts used to minimize the lateral spill of debris during raking.

FIG.2 is a plan view of one link

### DESCRIPTION OF THE PREFERRED EMBODIMENT

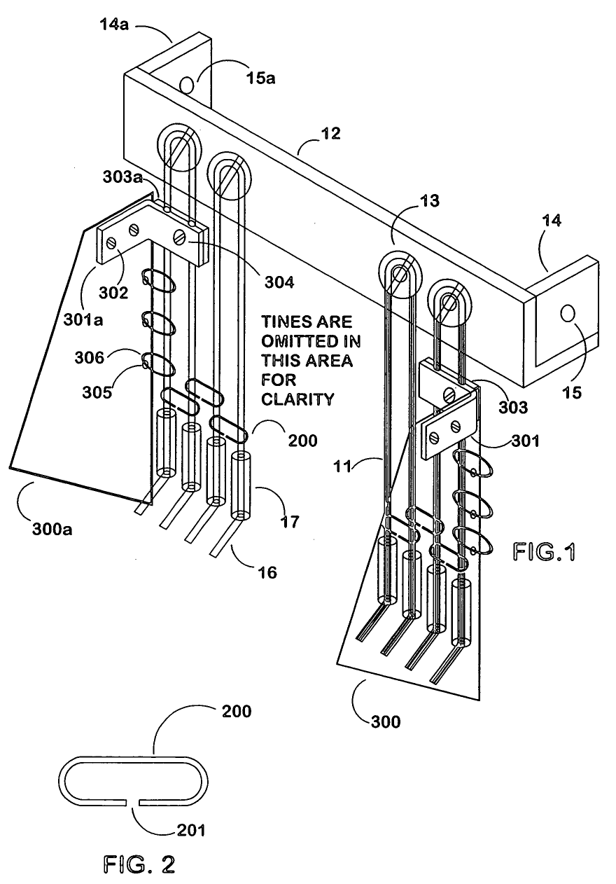

Referring to FIG. 1 a plurality of tines 11 are anchored to a raking head member 12. Said tines 11 are made of very flexible steel and preferably of round cross section. Two tines 11 are formed by bending a long heat treated steel rod in U-shape. The close end of the U-shaped tines is secured with screws 13 to said raking head member 12, that may be provided with proper appurtenances to be attached to a lawnmower as in my previous invention, or can be arranged with integral propel source. Said tines 11 extend downwardly from the raking head. Said raking head 12 has a first and second end caps 14 and 14a respectively. Said end caps 14 and 14a have respectively threaded bores 15 and 15a on line with the axis of said raking head member 12. Said tines 11 have a small portion 16 of their free end bent in planes perpendicular to an axial plane of said raking head member 12. Said tines 11 may be built from untreated steel rods and hardened after all bends are made. Beads 17 are preferably of ellipsoidal shape and of heavy material. Said beads 17 have a bore along their axis of diameter greater than the diameter of said tines 11. Each tine 11 is inserted inside the bore of at least one bead 17 before 16 is bent. Said beads 17 can rotate and slide on said tines 11 but are prevented to scape by said 16. Said beads 17 may have an axial slot to introduce said tines 11 into said axial bore that can be closed by compression after said tines 11 are introduced into said axial bore. Laminar side skirts 300 and 300a are preferably of trapezium shape with one side secured to one leg of angular brackets 301 and 301 a respectively by bolts 302. The other legs of said angular brackets 301 and 301 a are clamped each to at least one extreme pair of tines 11 by means of plates 303 and 303a and bolts 304. Said extreme pairs of tines 11 are sandwiched between said angular bracket 301 and said plate 303; and said angular bracket 301a and said plate 303a respectively. A plurality of holes 305 are disposed along one side of said laminar side skirts 300 and 300a collinear with the most extreme tine 11. A ring 306 is inserted in each hole 305 embracing said extreme tine 11, allowing said laminar side skirts 300 and 301 to pivot around said extreme tines 11 under the action of gravity and rake motion. Another side of said laminar side skirts 300 and 301 is cut in a manner to be parallel to ground when the lawn rake is in operational position.

Tines 11 are linked to each other near their working ends by links 200. Said links 200 are of elliptical shape with their long inner dimension slightly greater than said tines 11 separation. Short inner dimension of 200 is slightly greater than said tines 11 diameter. Said links 200 are slidable along the tine length and are prevented to escape by beads 17.

Referring to FIG. 2 link 200 has a gap 201 slightly greater than tine 11 diameter to allow insertion of said tines 11. Said gap 201 may be closed by compression after tine insertion or can be left open.

The present disclosure contains that contained in the appended claims as well as that of the foregoing description. Although the invention has been disclosed in its preferred forms with a certain degree of particularity, it is understood that the invention of the preferred form has been made by way of example, that numerous changes in the details of construction and the combination and arrangement of parts may be resorted to without departing from the spirit and scope of the invention.

1. A lawn rake with trapezium shaped laminar side skirts to minimize lateral spill of debris.

2. A lawn rake with trapezium shaped laminar side skirts to minimize lateral spill of debris as set forth in claim 1 wherein means are provided to secure said trapezium shaped laminar side skirts to at least a pair of extreme tines near the tine head.

3. A lawn rake with trapezium shaped laminar side skirts to minimize lateral spill of debris as set forth in claim 1 wherein means are provided to hinge said trapezium shaped laminar side skirts to the most extreme tine in order to swing under the action of gravity and rake motion.

4. A method to prevent permanent deformation of rake tines, and maintain tine separation consisting in providing slidable elliptical shaped links between adjacent tines near their working end.

5. A method to prevent permanent deformation of rake tines, and maintain tine separation consisting in providing slidable elliptical shaped links between adjacent tines near said working end as set forth in claim 4 wherein the inner long dimension of said elliptical shaped link is slightly greater than the tine separation and the inner short dimension of said elliptical shaped link is slightly greater than the tine diameter.

6. A method to prevent permanent deformation of rake tines, and maintain tine separation consisting in providing slidable elliptical shaped links between adjacent tines near said working end as set forth in claim 4 wherein the links allow each tine to bend within normal range to follow the terrain contour and movement of the lawnmower.

7. A method to prevent permanent deformation of rake tines, and maintain tine separation consisting in providing slidable elliptical shaped links between adjacent tines near said working end as set forth in claim 4 wherein when a tine bend exceeds said normal range, the bending forces are distributed among other tines.
